(19) United States
(12) Patent Application Publication
(10) Pub. No.: US 2018/0051212 A1
(43) Pub. Date: Feb. 22, 2018

(54) MATERIAL FOR PRODUCING AN ELECTRO-OPTICAL SHUTTER DEVICE HAVING THREE TRANSMISSION STATES, CORRESPONDING DEVICE AND USES THEREOF

(71) Applicants: INSTITUT MINES TELECOM, Brest Cedex 3 (FR); EYES TRIPLE SHUT, Paris (FR)

(72) Inventors: Jean-Louis De Bougrenet De La Tocnaye, Guilers (FR); Laurent Dupont, Plouzane (FR); Kedar Sathaye, Brest (FR); SumanKalyan Manna, Brest (FR)

(21) Appl. No.: 15/555,732

(22) PCT Filed: Feb. 26, 2016
(86) PCT No.: PCT/EP2016/054120

§ 371 Date: Sep. 5, 2017

(30) Foreign Application Priority Data
Mar. 3, 2015 (FR) 1551764

(51) Int. Cl. C09K 19/58; C09K 19/60; G02F 1/137; G02F 1/1347

(52) U.S. Cl. CPC C09K 19/586; C09K 19/60; G02F 1/13471; G02F 1/13737; G02F 1/13725

(57) ABSTRACT

A material is proposed for making an electro-optical shutter device. The material includes a host nematic liquid crystal, at least one guest chiral dopant and one guest black dichroic dye. The birefringence (Δn) of the host nematic liquid crystal is greater than 0.20. The concentration of the at least one chiral dopant is adjusted so that the material has a pitch in the range of 500 nm to 800 nm. The concentration of the guest black dichroic dye ranges from 2% to 4% by weight of the material. The dichroic ratio of the guest black dichroic dye is greater than or equal to 8.

### 1. CROSS-REFERENCE TO RELATED APPLICATIONS

This Application is a Section 371 National Stage Application of International Application No. PCT/EP2016/054120, filed Feb. 26, 2016, the content of which is incorporated herein by reference in its entirety, and published as WO 2016/139150 A1 on Sep. 9, 2016, not in English.

### 2. FIELD OF THE INVENTION

The field of the invention is that of the designing and making of optical components using liquid-crystal-based materials.

More specifically, the invention relates to a liquid-crystal-based material (a mixture) intended for making electro-optical shutter devices (also called optical attenuator-shutters), that are preferably isotropic, with multiple transmission states, especially optical attenuator-shutters with three transmission states used to attain high contrast levels. These are polarizer-free devices (attenuators/modulators of light), using a host composite nematic liquid crystal mixture with at least one guest chiral dopant and one black dichroic dye, having a liquid crystal dark scatter state. Such devices need more than two transmission states with high contrast levels.

The invention can be applied especially but not exclusively to the making of anti-glare glasses, active 3D glasses and fast programmable shutters with switching times ranging from a few fractions of ms to several tens of ms.

### 3. TECHNOLOGICAL BACKGROUND

There already exist known ways of making an isotropic electro-optical shutter device by using a material comprising a host nematic liquid crystal, at least one guest chiral dopant and at least one guest dichroic dye.

A first known solution is proposed by the US patent application 2014/0226096A1 which describes a liquid-crystal-based shutter device implementing three transmission states with transmittance levels of 70%, 40% and 2% respectively: a clear state or low-haze low-tint state, corresponding to the homeotropic state (E3), a tinted state or a low-haze high-tint state, corresponding to the planar state (E1) and an opaque state or low-haze, low-tint state corresponding to a dynamic scattering state which is not the focal conic state (E2). More specifically, in one example of an embodiment, the liquid-crystal-based mixture comprises a cholesteric liquid crystal (a nematic liquid crystal and one or more chiral dopants) and at least one dichroic dopant. The ratio (d/p) between the thickness (d) and the pitch or helix pitch (p for pitch) is smaller than 1.5. The technique described in this document does not implement the focal conic state (E2) but relies on ionic effects to generate a dynamic scattering state through the use of an ionic dopant (cf. §[0078], [0079] and [0113] of this patent document).

A second known solution is proposed in the US patent application 201010039595A1 which describes a liquid crystal device comprising a dichroic dye and a chiral compound such that the ratio between the pitch and the thickness of the liquid crystal material ranges from 0.006 to 1.0. The pitch ranges from 1 to 5 μm.

A third prior art solution is proposed in the article by Chun-Ta Wang and Tsung-Hsien Lin, “Bistable reflective polarizer-free optical switch based in dye-doped cholesteric liquid crystal” (Optical Material Express, 2011, Vol. 1, No. 8-2011) which describes a dye-doped cholesteric liquid crystal (DDCLC) material comprising a cholesteric liquid crystal (CLC) and a dichroic dye. This article proposes to use, and to switch, between two stable states obtained with a pitch of 220 nm (the mixture is chosen to be reflective (in the planar state) in the ultraviolet, these two states being a planar state (E1), considered to be the opaque or the dark state, and the uniformly-lying helical state (ULH) considered to be the (bright state). This article also mentions the use of the focal conic state (E2) as the dark state (instead of the planar state (E1)), with a pitch of 380 nm to reduce the control voltage, but at the same time advises against it because it introduces contrast. In other words, this article seeks to obtain neither an optimal blocking state in the focal conic state (E2) nor a semi-transparent state (intermediate state) in the planar state (E1).

In short, none of the three known solutions proposes a material that can be used to obtain an electro-optical shutter device with three transmission states respectively corresponding to the planar state (E1), the focal conic state (E2), and the homeotropic state (E3), with high contrast levels.

### 4. SUMMARY OF THE INVENTION

One particular embodiment of the invention proposes a material for obtaining an electro-optical shutter device, said material comprising a host nematic liquid crystal, at least one guest chiral dopant and one guest black dichroic dye. This material has the following characteristics:

the birefringence (Δn) of the host nematic liquid crystal is greater than 0.20;

the concentration of the at least one chiral dopant is adjusted so that the material has a pitch in the range of 500 nm to 800 nm;

the concentration of the guest black dichroic dye ranges from 2% to 4% by weight of said material; and

the dichroic ratio of the guest black dichroic dye is greater than or equal to 8.

Thus, a liquid crystal material with a specific composition is proposed. Indeed, action is taken on three types of parameters taken in combination to simultaneously optimize the transmission performance characteristics of the planar state (E1), as an absorbent and not as a reflector, and of the focal conic state (E2). The choice of these three types of parameters and the specification of their ranges of values is at the center of the inventive concept. These three types of parameters are (a) the birefringence of the nematic liquid crystal, (b) the value of the pitch which will optimize both the absorption of the planar state (E1) and the achromatisation of the scattering focal conic state (E2) and (c) the concentration and the dichroic ratio of the black dichroic dye.

The fact of using high birefringence greater than 0.20 in combination with a pitch of 500 nm to 800 nm increases the scattering effect. The fact of having a black dichroic dye (a dye that is neutral at the chromatic plane) ensures achromatic absorption. The combination of high birefringence, a pitch of 500 to 800 nm and the use of a black dichroic dye leads firstly to optimizing the absorption of the planar state (E1) and secondly to obtaining a scattering effect and achromatic absorption in the focal conic state (E2) (optimizing the two effects that achieve attenuation in the focal conic state: attenuation by absorption and attenuation by scattering).

When this material is addressed electrically in an appropriate way, it enables the creation of at least three isotropic attenuation states, making it possible to obtain a function of uniform light intensity filtering in the visible spectral band (without achromatic effect). These states include (i) an open state corresponding to the homeotropic state (E3), the transmittance of which is situated for example between 70% and 80%, (ii) a blocking state corresponding to the focal conic state (E2), the transmittance of which is for example lower than 1% and (iii) an intermediate state corresponding to the planar state (E1), the transmittance of which ranges for example from 35% to 45%. These states are maintained by application of a form of electrical field or else they are stable states intrinsic to the material.

According to one particular characteristic, the viscosity of the host nematic liquid crystal is lower than or equal to 400 mPa·s at the temperature of 20° C.

In this way, the performance of the material is further improved. According to one particular characteristic, the differential dielectric permittivity (Δε) of the host nematic liquid crystal is greater than or equal to 15.

This reduces the voltage values applied to achieve the homeotropic state (E3) and the focal conic state (E2).

According to one particular characteristic, the host nematic liquid crystal is a dual frequency liquid crystal.

The use of a dual frequency liquid crystal accelerates the switching time between states of the material when a voltage signal is applied.

In another embodiment, the invention proposes an electro-optical shutter device comprising at least one cell comprising, between two plates of optically transparent material, a layer of material as referred to her above (according any one of the embodiments).

According to one particular characteristic, the layer of material possesses a thickness of 3 μm to 6 μm.

According to one particular characteristic, the electro-optical shutter device comprises means for applying a voltage signal between two electrodes each disposed on one of the two plates of optically transparent material, the means for applying being configured to make said at least one cell selectively attain one of the following states, according to the voltage signal applied:

a homeotropic state (E3) that is substantially transparent and associated with a first transmittance value,

a planar state (E1) that is substantially semi-transparent and associated with a second value of transmittance lower than the first value of transmittance, and

a focal conic state (E2) that is substantially opaque and associated with a third value of transmittance lower than the second value of transmittance.

According to one particular characteristic, for a wavelength of 400 nm to 700 nm:

the first value of transmittance is higher than or equal to 65%;

the second value of transmittance is included in the range of 30% to 45%; and

the third value of transmittance is lower than 3%. According to one particular characteristic, the means for applying are configured so that the voltage signal possesses:

a first level of amplitude ranging from 25 V to 35 V, to make the at least one cell attain the homeotropic state (E3);

a second level of intermediate amplitude ranging from 3% to 25% of the amplitude of the first level, to make the at least one cell attain the focal conic state (E2); and

a third level of amplitude=0 V to make the at least one cell attain the planar state (E1).

According to one particular characteristic, the voltage signal possesses a frequency of 0.5 Hz to 100 Hz.

Various uses of the above-mentioned device are possible, and especially (but not exclusively):

for making a mask or a pair of sunglasses with three states;

for making a liquid-crystal panel with variable transmission rate; and

for making a picture element (pixel) of a liquid crystal screen.

### 5. LIST OF FIGURES

Other features and advantages of the invention shall appear from the following description, given by way of an indicative and non-exhaustive example and from the appended drawings, of which:

FIG. 1 presents a simplified structure of an electro-optical shutter device according to one particular embodiment of the invention;

FIG. 2 illustrates the known structure of a cholesteric liquid crystal;

FIG. 3 illustrates the known principle of addressing the three states E1, E2 and E3 of a cholesteric liquid crystal;

FIG. 4 presents several curves illustrating the evolution of the scattering coefficient as a function of the wavelength for different sizes of scattering structures;

FIG. 5 illustrates two modes (static and dynamic) of electrical addressing of the cell for a material according to one particular embodiment of the invention;

FIG. 6 is a spectrogram of transmission for the states E1, E2 and E3 according to one particular embodiment of the invention.

### 6. DETAILED DESCRIPTION

In all the figures of the present document, the identical elements and steps are designated by a same numerical reference.

Referring to FIG. 1, we present the simplified structure of an electro-optical shutter device 100 according to one particular embodiment of the invention.

The incident light (represented by the arrow A) that arrives at the shutter device 100 is considered, for example, to be non-polarized and to have a wide spectral band in the visible range (substantially between 400 nm and 700 nm).

The electro-optical shutter device 100 comprises a cell 1 itself comprising, between two plates of optically transparent material 2, 3 (for example optical glass plates), a layer of material (a mixture) 4 (the composition of which is discussed in detail here below) switchable between different states (E1, E2 and E3). The electro-optical shutter device 100 also comprises means 5 for applying a voltage signal V between two electrodes each disposed on one of the two plates 2, 3. For example, each plate 2, 3 comprises, on its internal surface, a layer of indium-tin oxide (an optically transparent and electrically conductive material) forming a conductive electrode (not shown). The means for applying the voltage signal V are configured to make the cell 1 selectively attain one of the states E1, E2 and E3 depending on the voltage signal applied. They comprise for example a voltage source 51 (generating a voltage signal of variable amplitude, for example varying from 0V to 35V) and a switch 52 (enabling the application or non-application of the voltage signal V to the electrodes).

The material 4 contained in the cell 1 comprises a host nematic liquid crystal, at least one guest chiral dopant and one guest black dichroic dye.

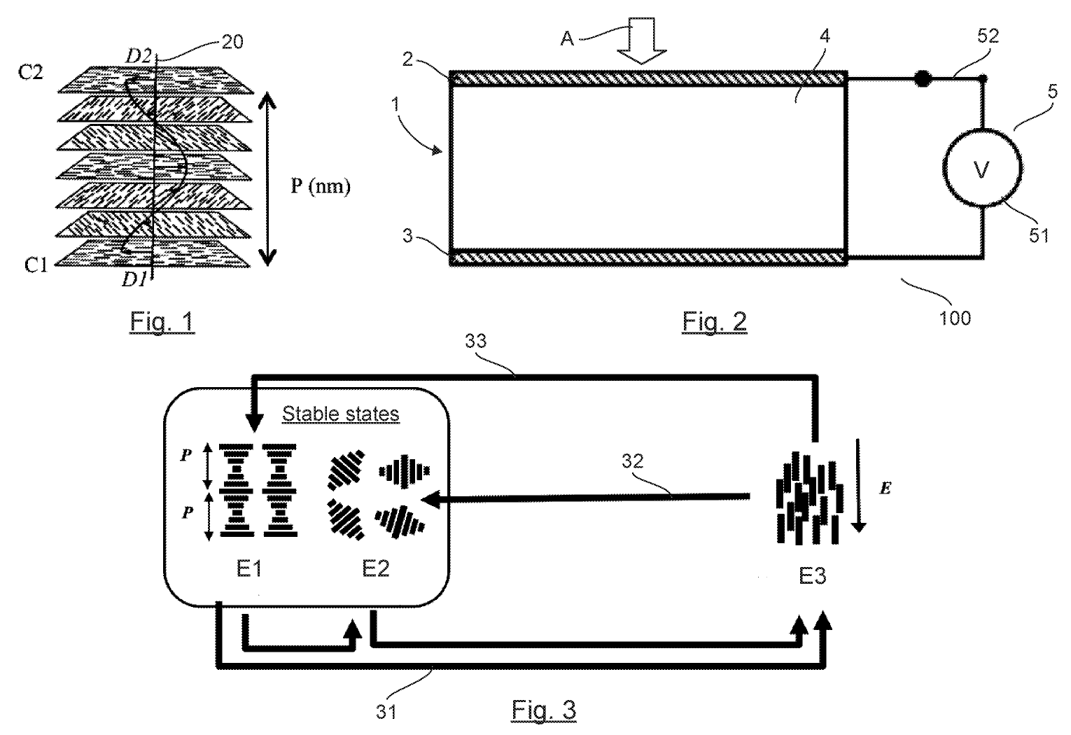

In other words, the liquid crystal used within the framework of the invention is of the cholesteric type. Indeed, in a known way, a cholesteric liquid crystal is a nematic liquid crystal comprising one or more chiral dopants. This mixture forms several layers, each characterized by a particular orientation of the molecules along a “director” (the director designates the mean orientation of the molecules in each layer). As illustrated in FIG. 2, the director of the different layers develops in such a way as to form a helix. By definition, the pitch (P) of this helix corresponds to the length (nm) between two layers (C1, C2) having a same director (i.e. the same direction and the same sense: \vec{D1}=\vec{D2}). The pitch of the helix can be modified according to the concentration of chiral dopant.

Cholesteric liquid crystals possess two stable states (E1, E2) corresponding to two distinct phases:

a planar phase (E1) where the helical axis 20 is perpendicular to the plates of the liquid crystal cell (in a reflective state in a reflective spectral band characteristic of the cholesteric liquid crystal and transparent outside this band); and

a phase known as the focal conic phase (E2) where the helical axes are oriented randomly (scattering state).

To select one of these two stable states (E1, E2) it is necessary to pass through an intermediate unstable state called a “homeotropic” state (E3). The application of an electrical field of increasing amplitude (using the voltage signal V) enables the successive passage from the focal conic state (E2) to the homeotropic state (E3) or from the planar state (E1) to the homeotropic state (E3) in passing through the focal conic state (E2). Abruptly cutting off the field causes the homeotropic state (E3) to relax into the planar state (E1). Abruptly cutting off the field in a focal conic mode (E2) changes nothing since this is a stable state. If the electrical field is cut off slowly or partially, the system returns to the focal conic state (E2) starting from the homeotropic state (E3). These transitions are illustrated in FIG. 3. The arrows referenced 31, 32 and 33 respectively correspond to the following transitions: E1 to E2 and then E2 to E3, E3 to E2 and E3 to E1.

The use of an anisotropic black dye or again a black dichroic dye has the effect of increasing the absorption. Since the molecules of dye are elongated, they absorb light along one direction and are therefore absorbent anisotropes. A black dye corresponds to a mixture of several dyes. Thus, when the cholesteric liquid crystal is associated with an anisotropic black dye, it has its properties modified:

the planar state (E1) becomes absorbent (instead of being transparent) outside the particular reflective spectral band (visible or IR);

the focal conic state (E2) is simultaneously absorbent and scattering (instead of being only scattering); and

the homeotropic state (E3) remains transparent.

The phase of the scattering focal conic state (E2) is structured into domains, the size of which depends on the pitch (P) of the helix. The greater the pitch of the helix, the greater is the size of the domains. Now, the scattering effect depends on the size of the domains, the birefringence (An) and the thickness of the cell (d). Experimentally, the size of the domains used is in the range of the wavelength (Mie scattering regime). Under these conditions, the intensity of the scattered light varies with the wavelength according to an λ⁻ⁿ relationship with n varying from 4 to ≈0, when the size of the domains increases (achromatic geometrical scattering), but in this case the amplitude of the scattering phenomenon diminishes. This diminishing must be compensated for by the absorption effect of the dye and by an increase in the birefringence for a given constant thickness. This quality of being achromatic is obtained for fairly high pitch values (the reflected wavelengths are clearly in the infrared). The concentrations in chiral dopants are typically 7% to 15%.

For the planar state (E1), the sensitivity to the polarization of light diminishes when the pitch diminishes (for a given cell thickness). This comes from the fact that for de-polarized light, the greater the phenomenon of absorption appears to be isotropic, the greater will be the absorption. Thus, for a uniform nematic liquid crystal, whatever the concentration in dopant and whatever the thickness of the cell, the absorption can never exceed 50%. In each layer, the molecules of black dye are oriented along the director. The distribution of the directors enables absorption by each layer in a specific direction enabling absorption in all directions by combination of the different layers (i.e. isotropic absorption). To optimize the absorption of the planar state, (E1) (as an absorbent state and not as a reflective state) and its isotropic quality, the pitch ranges from 500 to 800 nm.

As already mentioned further above, the innovative character of the invention lies in the composition of the material (mixture) and more specifically in the fact of acting on three types of parameters taken in combination to simultaneously optimize the transmission performance of the planar state (E1) and the conical state (E2). The choice of these three types of parameters and the specifying of their ranges of values is at the center of the inventive concept. These three types of parameters are (a) the characteristics of the nematic liquid crystal (birefringence, viscosity, differential dielectric permittivity), (b) the value of the pitch that will optimize both the absorption of the planar state (E1) and the achromatization of the scattering focal conic state (E2) and (c) the concentration and the dichroic ratio of the black dichroic dye for a given thickness.

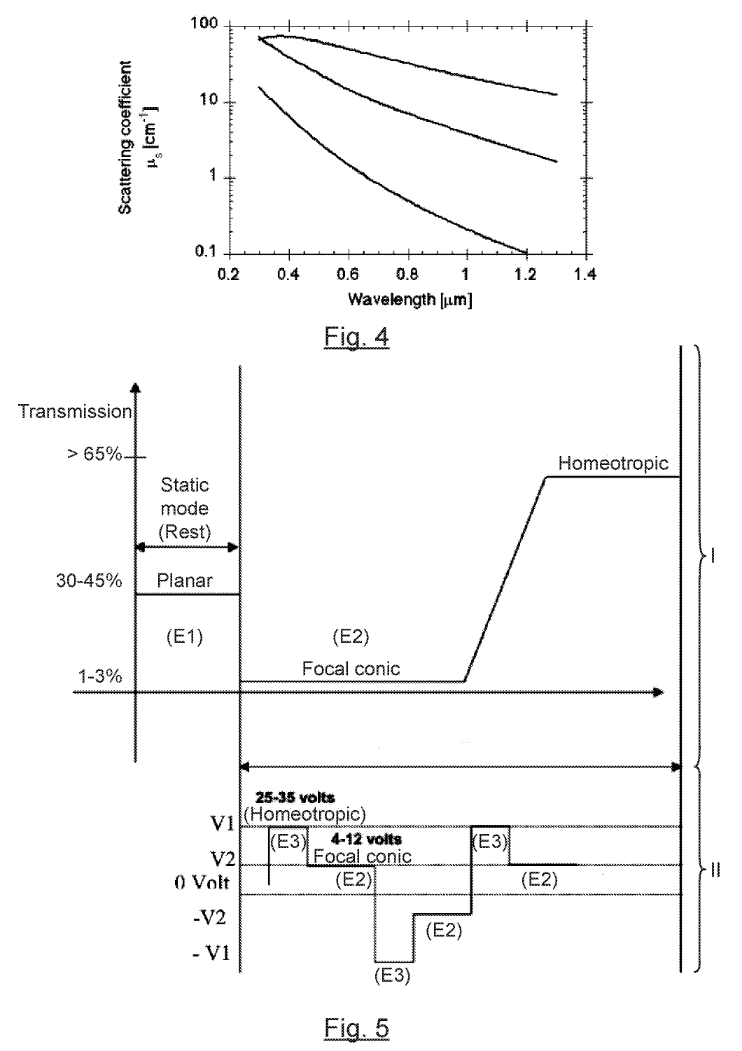

Given the scattering mechanism described further above, the choice of the pitch also has an impact on the scattering phase (E2). An optimum must therefore be found to optimize both the absorption of the planar state (E1) and the achromaticity and the additional attenuation by scattering of the focal conic state (E2). FIG. 4 illustrates the development of the scattering coefficient as a function of the wavelength for different sizes of scattering structures, for example defects sized 1,000 μm, 0.300 μm and 0.100 μm respectively, created in the focal conic phase (E2). These defects have a size of the order of the pitch. The greater this size relative to the wavelength, the less sensitive is the scattering to this wavelength (this is the case of achromatic scattering).

The idea is to obtain a blocking state (attenuation) that is optimal in the focal conic state (E2) by combining two effects: absorption and scattering. This is possible by simultaneously optimizing these two effects, involving the optimization of the size of the pitch, the birefringence and the concentration of the black dichroic dye aimed at obtaining an optimal focal conic state (E2).

As mentioned further above, the use of a cholesteric liquid crystal (CLC) with dichroic dopants is known in the literature. In general (see especially the above-mentioned article in entitled “Bistable reflective polarizer-free optical switch based on dye-doped cholesteric liquid crystal”), it is sought to optimize the planar state (E1) (as an absorbent and not as a reflector) in the visible domain (choice of pitch size from 200 to 350 nm). A focal conic state (E2) is then also observable in the visible range but, given the ratio between the wavelength and the size of the scattering structure (domains related to the size of the pitch), the intensity of the scattered light varies according to the wavelength as indicated further above. Achromatizing the scattering structure implies an increase in the domains (for example between 500 and 800 nm). In this case, the amplitude of the scattering phenomenon diminishes. One *way to increase it is to increase the birefringence of these domains.

The above spectral responses show the impact of the different parameters on the contrast and especially on the blocking states obtained with different chiral dopants in planar regime (E1) and in the focal conic state E2).

Thus, the proposed solution optimizes two effects, absorption and scattering, in a combined way, especially by making the absorption of the cell isotropic through the use of a pitch ranging from 500 to 800 nm (the mixture is reflective (planar state) in the near infrared) for a cell thickness of 3 μm to 6 μm. At the same time, the proposed solution optimizes the scattering property of the scattering structures, the size of the scattering elements relative to the wavelength and their variation in birefringence, so as to obtain a scattering structure with the highest possible scattering capacity while at the same time having a uniform spectral response in the visible band, which implies that the black dichroic dye is also neutral in said band.

The choice of the black dichroic dye is conditioned by its absorption characteristic (which is as neutral as possible), its miscibility and its dichroic ratio. The dichroic ratio (also called dichroic yield) is defined by A_{⊥}/A_{//} for a given material thickness, where:

α_{⊥}=e^{-A}^{_{⊥[}}^{C]d} : absorption coefficient for the extraordinary axis;

α_{//}=e^{-A}^{_{//}}^{[C]d}: absorption coefficient for the ordinary axis;

with d being the thickness of the material crossed and C being the concentration of the dye.

Thus, the transmission rate can be adjusted by selecting the concentration of dye (C), the thickness of the material and the dichroic ratio (A_{⊥}/A_{//}). According to one specific feature of the invention, the dichroic ratio of the black dye is greater than or equal to 8.

In one particular implementation, the material (mixture) is defined with the following characteristics:

black dichroic dye:
concentration: 2% to 4%;
dichroic ratio greater than or equal to 8;

chiral dopants (the concentration of chiral dopants is adjusted to modify the pitch of the cholesteric liquid crystal in the infrared domain):
concentration: 7 to 15%;
chiral dopant types: S811 (left-handed chirality) or R811 (right-handed chirality);
pitch (right/left): 500 to 800 nm;

thickness of the cell: 3 to 6 μm;

host liquid crystal:
type: nematic;
birefringence: >0.20;
viscosity: ≦400 mPa·s at the temperature of 20° C.;
differential dielectric permittivity: Δε>15 (the higher the value, the lower are the voltages applied). The differential dielectric permittivity Δε (there is no SI or other unit for this value) is defined as the difference between the permittivity values ε⊥ and ε// corresponding to the extraordinary and ordinary waves respectively.

In one particular mode of implementation, the invention uses a dual frequency nematic liquid crystal enabling the state transitions to be accelerated.

FIG. 5 illustrates two modes (static and dynamic) of electrical addressing of the cell for a material according to one particular embodiment of the invention.

The use of the material (mixture) described in detail here above to make an electro-optical shutter device requires a matching of the signals applied to enable proper addressing of all three states E1, E2 and E3. Under the effect of an appropriate electrical signal (voltage signal V, see FIG. 1), the mixture enables the optimizing of the scattering effect in the focal conic state E2 (efficiency of scattering and lower sensitivity to the wavelength).

The addressing of the planar state (E1) and the focal conic state (E2) is done electrically from the homeotropic state (E3) in abruptly or partially cutting off the electrical field at the terminals of the cell (cf FIG. 3). To reach the focal conic state (E2), the amplitude of the voltage signal passes from a high amplitude V1 (25 to 35 V) applied at the state E3 to a holding amplitude V2 that is far lower (between 3% and 25% of V1 for example 4 to 12 V). To obtain the planar state (E1), the field is cut off totally and rapidly (i.e. the amplitude of the voltage signal passes from the high value V1 to the value V3=0). Thus, the state E1 is obtained with a static addressing mode (rest) with V3=0V. The states E3 and E2 are obtained with a dynamic addressing mode, with V1 and V2 respectively.

The frequency of the applied voltage signal ranges from 0.5 Hz to 100 Hz.

The lower part (II) of FIG. 5 presents an example of a timing diagram of the voltage signal V for the addressing of the states E2 and E3 in dynamic mode. Through the application of a high-intensity electrical field, using a control voltage equal to +30V for example, the cell switches into the homeotropic state E3. Then, through the application of a low-intensity electrical field, using a control voltage equal to +3V for example, the cell switches over into the focal conic state E2. Then, to switch the cell again into the state E3, a high-intensity electrical field is applied again, but this is done by means of a negative control voltage equal to −30V for example. Then, to switch the cell into the state E2, a low-intensity electrical field is applied again, but this is done by means of a negative control voltage equal to −3V for example. The fact of successively applying a cycle of high/low electrical fields with positive values and a cycle of high/low electrical fields with negative values ensures the efficient switching of the cell (the problems related to the ion charges are thus minimized). Naturally, it is possible to implement a control system based solely on electrical fields of positive values or solely on electrical fields of negative values.

The upper part (I) of FIG. 5 presents transmission levels associated with the states E1, E2 and E3 of the material: for E3, transmission level higher than or equal to the 65% threshold; for E1, transmission level in the 30% to 45% range; for E2, transmission level lower than or equal to a threshold itself included within the 1% to 3% range.

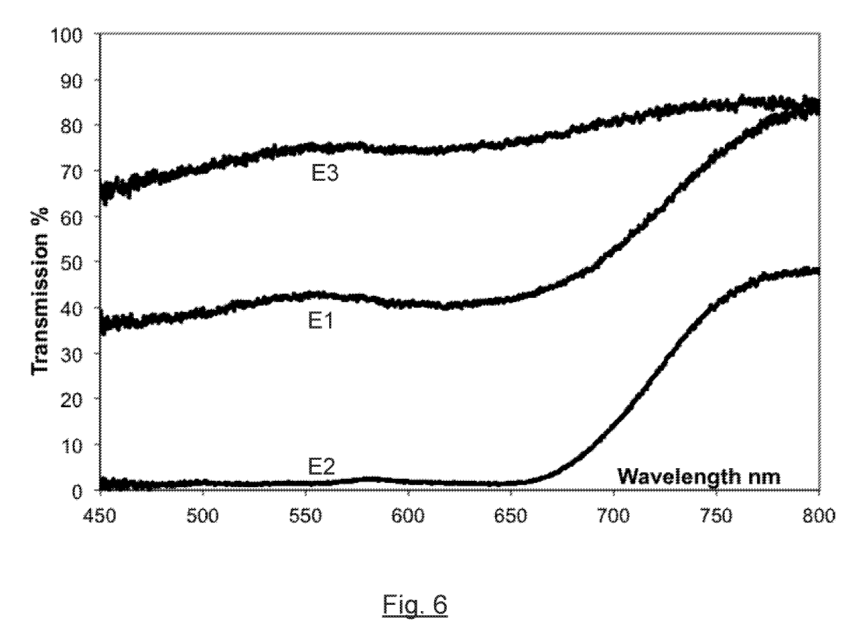

FIG. 6 is a spectrogram of transmission for the states E1, E2 and E3 according to one particular embodiment of the invention. It shows an example of optimization of the mixture to obtain high contrast between several states. In the present case, the presence of three states (E1, E2, E3) makes it possible to envisage a promising shutter solution for three-state shutter sunglasses (for a wavelength of 400 to 700 nm):

an open (on) state of high transmittance higher than or equal to 65% (corresponding to the state E3),

an intermediate state (sunglasses type, corresponding to a case of the use of a polarizer) with transmittance ranging from 30% to 45% (corresponding to the state E1), and

blocking (anti-glare) state with transmittance below 3% (corresponding to the state E2).

Many uses of the invention can be envisaged, for obtaining especially a mask or a pair of three-state sunglasses, a liquid crystal panel with variable rate of transmission, a picture element, a liquid crystal screen, etc.

An exemplary embodiment of the present application provides a technique for obtaining an electro-optical shutter device with three transmission states and with high contrast levels.

Although the present disclosure has been described with reference to one or more examples, workers skilled in the art will recognize that changes may be made in form and detail without departing from the scope of the disclosure and/or the appended claims.

1. A material for making an electro-optical shutter device, said material comprising:
a host nematic liquid crystal,
at least one guest chiral dopant; and
guest black dichroic dye, wherein:
the birefringence of the host nematic liquid crystal is greater than 0.20;
the concentration of the at least one chiral dopant is adjusted so that the material has a pitch in the range of 500 nm to 800 nm;
the concentration of the guest black dichroic dye ranges from 2% to 4% by weight of said material; and
the dichroic ratio of the guest black dichroic dye is greater than or equal to 8.

2. The material according to claim 1, wherein the viscosity of the host nematic liquid crystal is lower than or equal to 400 mPa·s at the temperature of 20° C.

3. The material according to claim 1, wherein the differential dielectric permittivity of the host nematic liquid crystal is greater than or equal to 15.

4. The material according to claim 1, wherein the host nematic liquid crystal is a dual frequency liquid crystal.

5. An electro-optical shutter device comprising at least one cell comprising:
first and second plates of optically transparent material; and
a layer of material between the first and second plates of optically transparent material, wherein said material comprises a host nematic liquid crystal, at least one guest chiral dopant and a guest black dichroic dye, wherein:
the birefringence of the host nematic liquid crystal is greater than 0.20;
the concentration of the at least one chiral dopant is adjusted so that the material has a pitch in the range of 500 nm to 800 nm;
the concentration of the guest black dichroic dye ranges from 2% to 4% by weight of said material; and
the dichroic ratio of the guest black dichroic dye is greater than or equal to 8.

6. The electro-optical shutter device according to claim 5, wherein the layer of material possesses a thickness of 3 μm to 6 μm.

7. The electro-optical shutter device according to claim 5, wherein the device comprises means for applying a voltage signal between two electrodes each disposed on one of the two plates of optically transparent material, the means for applying being configured to make said at least one cell selectively attain one of the following states, according to the voltage signal applied:
a homeotropic state that is substantially transparent and associated with a first transmittance value,
a planar state that is substantially semi-transparent and associated with a second value of transmittance lower than the first value of transmittance, and
a focal conic state that is substantially opaque and associated with a third value of transmittance lower than the second value of transmittance.

8. The electro-optical shutter device according to claim 7, wherein for a wavelength of 400 nm to 700 nm:
the first value of transmittance is greater than or equal to 65%;
the second value of transmittance is included in the range of 30% to 45%; and
the third value of transmittance is lower than 3%.

9. The electro-optical shutter device according to claim 7, wherein the means for applying are configured so that the voltage signal possesses:
a first level of amplitude ranging from 25 V to 35 V, to make the at least one cell attain the homeotropic state;
a second level of intermediate amplitude ranging from 3% to 25% of the amplitude of the first level, to make the at least one cell attain the focal conic state; and
a third level of amplitude equal 0 V to make the at least one cell attain the planar state.

10. The electro-optical shutter device according to claim 7, wherein the voltage signal possesses a frequency of 0.5 Hz to 100 Hz.

11. A mask, which comprises two electro-optical shutter devices according to claim 5 and three states.

12. A liquid-crystal panel comprising the electro-optical shutter device according to claim 5 and having a variable transmission rate.

13. A picture element of a liquid crystal screen comprising the electro-optical shutter device according to claim 5.

14. A pair of sunglasses, which comprises two electro-optical shutter devices according to claim 5 and three states.
